(19) United States
(12) Patent Application Publication
(10) Pub. No.: US 2021/0110426 A1
(43) Pub. Date: Apr. 15, 2021

(54) VISUAL ATTENTION MEASUREMENT SYSTEMS AND METHODS

(71) Applicant: Debra Hibbard, White Bear Lake, MN (US)

(72) Inventor: Debra Hibbard, White Bear Lake, MN (US)

(21) Appl. No.: 16/498,894

(22) PCT Filed: Mar. 28, 2018
(86) PCT No.: PCT/US18/24883

§ 371 Date: Sep. 27, 2019

Related U.S. Application Data
(60) Provisional application No. 62/477,678, filed on Mar. 28, 2017.

(51) Int. Cl. G06Q 30/02

(52) U.S. Cl. CPC G06Q 30/0242; G06Q 30/0265; G06Q 30/0261; G06Q 30/0201

(57) ABSTRACT

Embodiments relate to detecting the effectiveness of advertisements and other messages on remote platforms such as trucks or billboards. In some embodiments, advertisements can not only be measured for effectiveness including quantity and quality of engagement with the public, but also advertisements on remote platforms can be modified as desired.

### RELATED APPLICATION

The present application is a National Phase entry of PCT Application No. PCT/US201824883, filed Mar. 28, 2018, which claims priority from U.S. Provisional Application No. 62/477,678, filed Mar. 28, 2017, each of which is hereby fully incorporated herein by reference

### TECHNICAL FIELD

Embodiments described herein can be used in mobile or stationary visual advertising systems. For example, the disclosed systems may include presence or proximity detectors.

### BACKGROUND

Advertisements are conventionally positioned in a variety of locations where potential customers are likely to encounter them. For example, advertisements have conventionally been placed on media broadcasts including radio and television broadcasts. Visual advertisements are also placed in a variety of locations where they are likely to be encountered by a wide variety of people on a regular basis. For example, billboards, newspaper advertisements, or other similar media can be used to deliver an advertisement to a particular demographic (e.g., highway users and newspaper readers).

In more recent times, efforts have been made to determine how many users an advertisement reaches. For the billboard described above, estimates of viewer engagement can be made based upon the number of drivers and passengers who traverse a particular stretch of highway on which a billboard is placed. That data can be combined with other data that indicate how many of those drivers and passengers are likely to actually see the billboard as they pass by.

With the advent of digital, online advertising, more specific data can be collected. For digital media, it is much easier to collect data concerning how many people accessed a website, how many of those users clicked on or “hovered over” a particular advertisement, how long the user remained engaged with the advertisement, and other relevant information that helps an advertiser determine the reach of the advertisement. Various methods for improving these systems are known in the art, such as U.S. Patent Application Pub. No. 2004/0243704 to Bothelo et al.

In addition to determining how many users engage with a particular advertisement, some conventional systems track how many users view an advertisement that is relevant to them. For example, delivering an advertisement to a user who has made purchases similar to an advertised product in the past may be more important than delivering the same advertisement to a general or anonymous member of the public. For this reason, advertisements are often strategically placed. Online, advertisements may be placed on websites that are likely to be frequented by a desired demographic. For physical advertisements, advertisements can be placed in locations where a target demographic is likely to be found (e.g., new vehicle advertisements on billboards by a major highway), or in a type of media likely to be purchased by that target demographic (e.g., fitness equipment advertisements in a fitness-themed magazine).

This concept, referred to as geomarketing, incorporates location intelligence to target particular messages to relevant consumers. Geomarketing can be used to provide advertisements for goods or services based on where they are or on what locations they have previously visited. Therefore geomarketing may have both a geographic component and a temporal component to determine the relevance of advertisements.

Despite best efforts of physical or out-of-home advertisers, it remains much easier to measure the effectiveness of online advertisements, due to tools such as “cookies,” page-counts, and click-counts that allow an advertiser to determine with some precision how many people engaged with the advertisements, and who those people were. In comparison, the effectiveness of physical or other out-of-home advertisements is often based more upon models, estimates, and indirect data, because it is more difficult to determine actual engagement with the advertisement.

### SUMMARY

In a first embodiment, a system for measuring engagement with a message is described. The system includes a first plurality of remote messaging platforms. A second plurality of sensors are also provided, each associated with a corresponding one of the first plurality of remote messaging platforms. Each of the second plurality of sensors is configured to detect a level of engagement with a message associated with the corresponding one of the first plurality of remote messaging platforms. In one embodiment, at least one of the first plurality of remote messaging platforms comprises a screen arranged along a rear of a truck.

According to another embodiment, a method for measuring a level of engagement with each of a plurality of remote messages is provided. The method includes providing a first plurality of remote messaging platforms, and providing a second plurality of sensors, at least one of the second plurality of sensors corresponding to each of the first plurality of remote messaging platforms. The method further includes detecting, at each of the second plurality of sensors, a level of engagement with a message associated with the corresponding one of the first plurality of remote messaging platforms.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a simplified plan view of a system for detecting visual engagement with an out-of-home advertisement according to an embodiment.

FIG. 2 is a simplified plan view of a system for detecting visual engagement with an out-of-home advertisement according to an embodiment.

FIG. 3 is a simplified schematic diagram of a system for communicating engagement with out-of-home advertisements according to an embodiment.

FIG. 4 is a simplified plan view of a system for detecting visual engagement with an out-of-home advertisement according to an embodiment.

FIG. 5 is a simplified schematic diagram of a system for communicating engagement with out-of-home advertisements according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

In embodiments described herein, a “visual click” visual attention measurement system for Out Of Home (OOH) advertising is disclosed. Such systems facilitate the measurement of actual visual engagement with OOH advertisements. As such, the particular value of OOH advertisements can be more accurately determined.

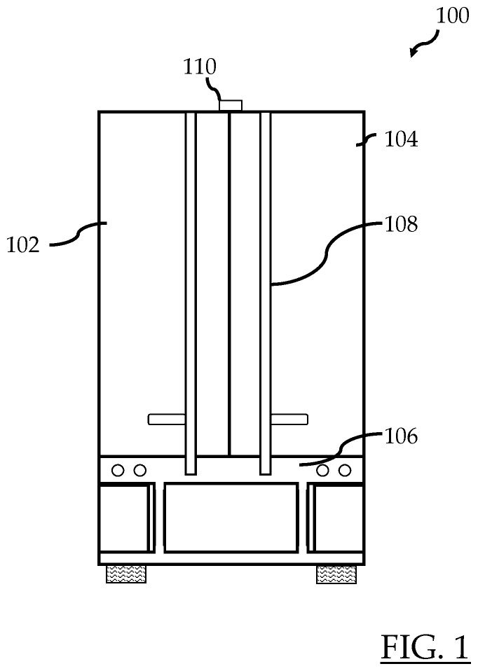

FIG. 1 is a plan view of a back end of a truck 100. Vehicles such as truck 100 can be used as mobile advertisement or message delivery platforms. For example, messages regarding the brand or owner of truck 100, the brand of the materials being delivered in truck 100, or even unrelated messages such as advertisements for other products or public-service messages can be delivered on truck 100.

Truck 100 includes a left door 102 and a right door 104, in the embodiment shown in FIG. 1. Left door 102 and right door 104 terminate at bed 106, and are held shut by locking bars 108. Scanner 110 is positioned on truck 100.

In alternative embodiments, truck 100 may have different arrangements of doors, locking bars, or scanners, some of which are described with respect to subsequently-depicted embodiments. One of ordinary skill in the art will recognize that system 100 could be deployed in other systems having rolling doors, lift gates, or other conventional features that comprise or cover parts of the back of truck 100.

Left door 102 and right door 104 can make up a large space on which advertisements or other messages can be positioned. Many truck trailers include doors (102, 104) that are about 2.5 m wide and about 3.5-4 m tall.

In the embodiment shown in FIG. 1, truck 100 can be used to deliver goods over a large distance, and any advertisement or other message placed on the left door 102 and/or right door 104 of truck 100 may be seen at various locations by different individuals. Conventionally, it is difficult to determine how many individuals saw any messages delivered on truck 100, whom those messages may have been seen by, or any other data such as how long the message was seen by any given viewer, who the viewer was, or whether the advertisement or message is even relevant to that person.

Scanner 110 facilitates determination of at least some information regarding views of an advertisement or message on truck 100. In embodiments, scanner 110 can be a license plate scanner. In such embodiments, scanner 110 may be used to determine how many unique views of truck 100 occurred during a given time period. Furthermore, scanner 110 may in some embodiments determine how long each view lasted.

Scanner 110 is arranged to measure views of doors 102 and 104. That is, scanner 110 measures a number of viewers who are positioned directly behind truck 100 for long enough to capture a reading of a front license plate.

In this or other embodiments, a video camera, proximity sensor, or other sensors and combinations thereof can be added to determine additional relevant information. For example, in embodiments an advertiser may wish to know how close to doors 102 and 104 another driver may have been, how long that person was within visual range of doors 102 and 104, or how many occupants are present in all or a portion of vehicles detected in this way.

In some embodiments, data relating to a particular driver or vehicle can be accessed. For example, an advertiser may be more interested in delivering advertisements to a particular type of driver such as SUV drivers, semi-truck drivers, or sedan drivers. License plate data can be used in some embodiments, where publicly accessible information related to a particular license plate is available. In other embodiments, system 100 may be directed to non-advertising uses of data acquired in this fashion. For example, where sensor 110 includes a license plate reader, system 100 could be used as a part of an “Amber Alert” system or other law enforcement task aimed at locating a particular individual. License plate readers could also be used to determine how many of the “views” of a particular advertisement or other piece of information are unique.

In embodiments, advertisements can be displayed based not only upon the identified driver or vehicle, but also by nearby advertisers or attractions. For example, long-haul trucks on freeways can be configured to advertise for restaurants, gas stations, local attractions, or points of interest that correspond to an upcoming freeway exit. Similarly, in urban locations nearby attractions or businesses could advertise on courier vehicles, ride-share vehicles, or other vehicles.

Trucks that travel long distances on interstate highways or freeways can be programmed to advertise with a particular “dwell time.” Dwell time, as used herein, describes the amount of time that a particular advertisement or other information will be displayed on the truck or other vehicle. By selecting an appropriate dwell time, an occupant of a vehicle behind a truck will see multiple displays. This increases the effectiveness of the delivery of information, and the total quantity of information or advertising delivered. Dwell time can be reset, in embodiments, when a different vehicle is detected in the area where the advertisement or other information is displayed.

In some embodiments, system 100 can collect data for later collection by an advertiser or other operator. This may be sufficient in embodiments where an advertiser simply wants to know how many views a particular mobile advertisement received, for example. In other embodiments, such as those in which law enforcement can collect data from system 100 to quickly locate certain vehicles, system 100 can include a mobile upload (not shown). The mobile uplink could be, for example, a cellular telephone connection, mobile wireless signal, satellite signal, or other wireless connections.

Overall, system 100 facilitates measurement of previously unquantified information relating to the number and extent of views of a particular advertisement mounted to a mobile platform. System 100 provides an improved level of precision to the actual market penetration of a mobile advertisement, including a number of unique views, duration of those views, and other previously unquantified data.

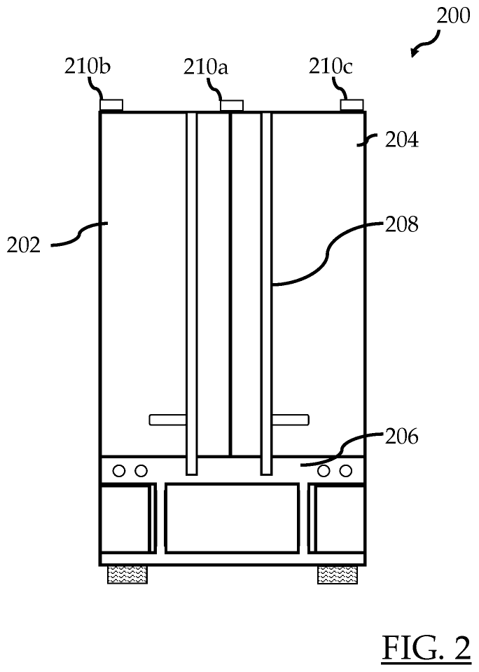

FIG. 2 depicts system 200, which is similar to the embodiment of system 100 described above with respect to FIG. 1, except that system 200 includes three sensors 210a, 210b, 210c. System 200 includes left door 202, right door 204, bed 206, and locking bars 208. In general throughout the application, like parts are labeled with reference numerals that are iterated by factors of 100 from their counterparts. Left door 202, right door 204, bed 206, and locking bars 208 are substantially similar to their counterparts (102, 104, 106, and 108) of FIG. 1.

System 200 can use sensors 210a, 210b, and 210c independently to detect vehicles behind, to the left of, and to the right of the truck, respectively. Alternatively, in embodiments sensors 210a, 210b, and 210c can detect multiple aspects of a vehicle behind doors 202, 204. For example, first sensor 210a can detect a license plate number, while second sensor 210b can detect proximity of a vehicle behind doors 202 and 204, while third sensor 210c can detect size, shape, or type of a vehicle behind doors 202 and 204. Other sensors 210 could, for example, detect a number of passengers in a vehicle that is within a particular range of system 200.

In other embodiments, any number of additional sensors could be deployed. In some embodiments, sensors could be deployed in alternative positions. It may be beneficial to place a license plate sensor at bed 206 or below, so that it will be more closely positioned to the license plate of a vehicle following system 200. In embodiments, side- or front-focused license plate reader sensors 210 can be employed. This can be particularly beneficial in areas where only rear license plates are used, and where a rear-focused license plate reader sensor 210 would not be capable of reading many license plates.

Different styles, sizes, and designs of vehicles may call for different numbers and arrangements of sensors (e.g., sensors 210a, 210b, 210c). A “sign truck” is a commonly-used vehicle for advertising in urban environments. A sign truck does not carry cargo, but rather includes a truck bed (similar to bed 106 or 206 of FIGS. 1 and 2) and a vertical, fin-style advertising board positioned to face left and right with respect to the direction of travel of the sign truck. In such embodiments, it may not be particularly relevant how many vehicles follow the sign truck. Rather, sensors could be deployed to measure how many drivers or pedestrians will view the side of the truck. Sensors could be arranged to measure data from vehicles passing or being passed by the sign truck, rather than vehicles following the sign truck, in such embodiments. Similarly, in areas with large numbers of pedestrians, different sensors may be deployed which detect a number of persons, rather than a number of vehicles, that are within visual range of a particular advertisement or other piece of information.

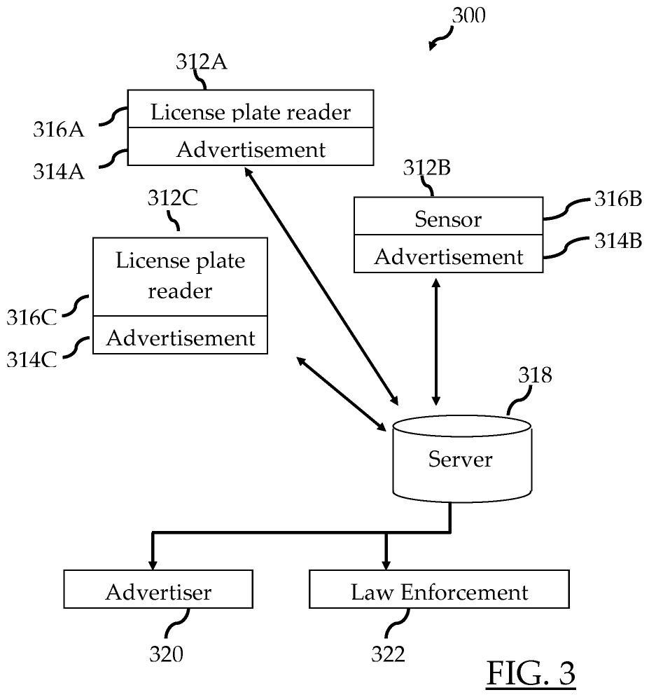

FIG. 3 is a simplified schematic of a data flow system 300 according to an embodiment. System 300 includes a plurality of remote advertising vehicles 312A-312C. First remote advertising vehicle 312A includes first advertisement 314A and first license plate reader 316A. Second remote advertising vehicle 312B includes second advertisement 314B and second sensor 316B. Third remote advertising vehicle 312C includes third advertisement 314C and third license plate reader 316C.

Second sensor 316B is not a license plate reader. Rather, second sensor 316B is some other type of sensor configured to measure one or more of a variety of data types other than license plate data. For example, sensor 316B could be a retina detector (similar to those deployed on cameras) to determine whether a person nearby advertisement 314B is actually looking at advertisement 314B. In other embodiments, sensor 316B could comprise a camera with a specific type of detection software. Detection software could include detection not only of retinal reflection, but of a viewer who smiles, turns his or her head, stops at or near advertisement 314B, or otherwise reacts in some way to advertisement 314B. In still further embodiments, sensor 316B can be one of a group of sensors and the output of those sensors can provide information to server 318 regarding multiple indicators of a “visual click” or engagement with the advertisement. For example, sensor 316B could be a camera that detects visual focus of a user on advertisement 314B, while a license plate reader simultaneously detects the license plate information of that user.

In various embodiments, there could be more or fewer remote advertising vehicles. In some embodiments, there can be several hundred or even thousands of remote vehicles, each having one or more advertisements. The advertisements on each remote vehicle can be the same or different. For example, first advertisement 314A can be the same as second advertisement 314B, but different from third advertisement 314C. In embodiments, each remote vehicle 312A-312C can include multiple advertisements, as described above. For example, a tractor trailer can include one or more advertisements on the back of the truck, as well as one or more advertisements on each side of the trailer.

Remote advertising vehicles 312A-312C can be tractor trailers, sign trucks, buses, trains, delivery vans, trains, or other vehicles having the capacity to display a message, advertisement, or other content.

Just as each vehicle 312A-312C can include one or more advertisements 314A-314C, each vehicle 312A-312C can also include one or more license plate readers 316A-316C. As described above, in embodiments each remote advertising vehicle 312A-312C can include a different type of sensor in lieu of or in addition to license plate readers 316A-316C.

As indicated by the arrows in FIG. 3, signal is sent from each of the remote advertising vehicles 312A-312C to server 318. Server 318 can be a dedicated server or a distributed or cloud-based server. Server 318 can store data relating to the quantity of views of each advertisement 314A-314C. In some cases, server 318 can store additional data related to the views such as the duration of each view, the number of views that were unique, or other data that indicates the quality of engagement between a viewer and the advertisements 314A-316C.

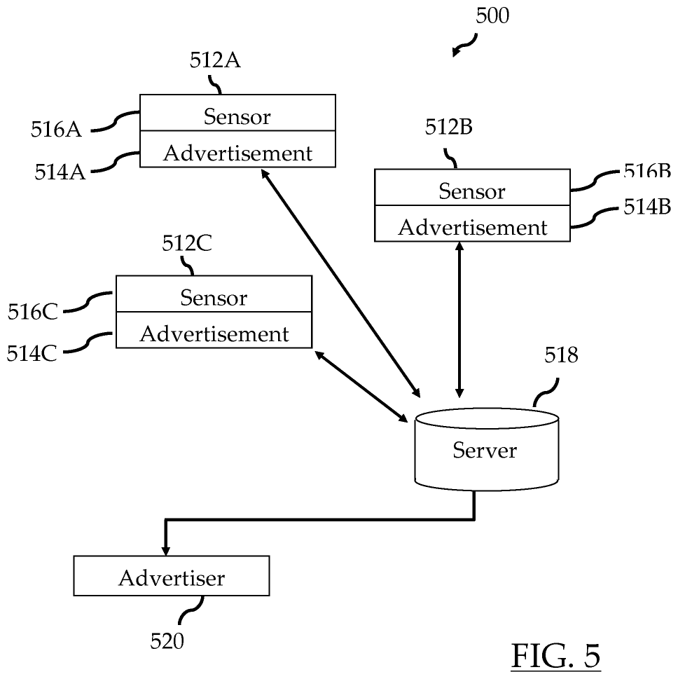

In alternative embodiments, advertisements can be delivered at stationary, rather than mobile, advertising platforms, as described in more detail with respect to FIG. 5. For example, in embodiments system 300 can include not just remote advertising vehicles 312A-312C but also billboards or other advertisements or messages delivered from a fixed location. Fixed/stationary advertisements or messages can include license plate readers or other sensors configured to detect the level of engagement between a viewer and that fixed/stationary advertisement or message. Data from each such fixed or stationary platform can be delivered to server 318 with specific data regarding the quality of an engagement with one or more drivers. For example, a billboard may record a higher-quality engagement with a driver during a traffic jam where the driver spends a more significant amount of time adjacent to the advertisement.

Such information can be transmitted to server 318 from remote advertising vehicles 312A-312C in a number of ways. For example, in embodiments data could be collected and uploaded wirelessly in real time from each remote advertising vehicle 312A-312C to server 318. In alternative embodiments, data could be collected and stored at a local memory at each remote advertising vehicle 312A-312C and uploaded to server 318 in batches.

Data stored at server 318 can be used to determine the effectiveness of a particular advertisement 314A-314C. For example, an advertiser may direct its advertisements to remote advertising vehicles 312A-312C that are more likely to engage with a particular type of viewer (such as viewers in a particular location) or those which have a higher number of total engagements, in embodiments. Similar to online “clicks” that indicate a number of quality engagements with advertising content, distributed and mobile physical advertisements can thus be measured for “visual clicks” in which a person actually engaged with the advertisement more than superficially. In such embodiments, data can be sent from server 318 to one or more advertisers 320.

Alternatively, data stored at server 318 can be used to prevent crime or assist law enforcement in apprehending particular drivers or vehicles. For those embodiments, it is often preferable to send data from each of the remote advertising vehicles 312A-312C to server 318 rapidly, such as by a wireless uplink. Data can be sent from server 318 to one or more law enforcement agencies 322, which can use that information to locate missing children, stolen vehicles, or vehicles belonging to persons with outstanding warrants, for example.

In some embodiments, such as the one shown in FIG. 3, data can be sent from server 318 to both advertisers 320 and law enforcement 322.

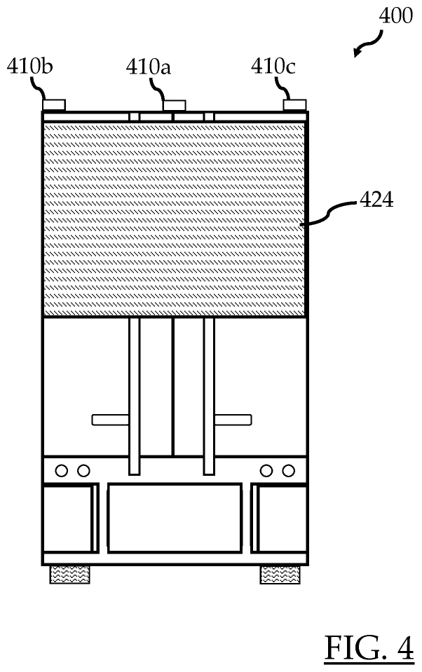

FIG. 4 is a plan view of the back end of a truck 400 having a plurality of sensors 410a-410c. As previously described with respect to other embodiments, sensors 410a-410c are one or more of a variety of sensors adapted to measure specific information relevant to the quantity and quality of visual engagements with an advertising surface of truck 400.

Unlike previously-described embodiments, the embodiment shown in FIG. 4 includes screen 424. Screen 424 is a specific structure designed for advertising. Screen 424 is a higher-quality advertising surface in that locking bars (e.g., locking bars 108 and 208 of FIGS. 1 and 2) are behind screen 424 from the perspective of a driver behind truck 400. Therefore the advertising surface of screen 424 is not obstructed as it would normally be in the embodiments shown in FIGS. 1 and 2.

Screen 424 can be, for example, a roll-out printed image that extends across the back of truck 400. Alternatively, screen 424 can be a flat panel printed with a particular advertisement. In still further embodiments, screen 424 can be a changeable surface such as an electronic display. Alternatively, screen 424 can be a printed graphic or a print graphic film, in embodiments. In embodiments, screen 424 can be displayed on the rear or the sides of a semi trailer, for example.

For changeable screens 424, the content of an advertisement or message on screen 424 can be modified to match a particular viewer. For example, where screen 424 is an electronic display and one or more of sensors 410a-410c detect that a driver is behind truck 400, an advertisement can be presented on screen 424 that is tailored to be as relevant as possible to that particular driver, or based on proximity to a local retailer. Sensors 410a-410c can then measure or detect the level of engagement between the driver and screen 424.

Depending on the level of engagement between the driver and the displayed advertisement or other message, future messages can be modified. For example, if sensors 410a-410c detect the same license plate number, past information regarding the level of engagement with various types of advertisements can inform the system which advertisements are most likely to be relevant to that driver in future.

FIG. 5 is a schematic view of a system 500 for tracking visual engagement with stationary out-of-home displays 512A-512C. As with the mobile advertising platforms 312A-312C of FIG. 3, embodiments of system 500 for use with stationary out-of-home displays 512A-512C could include more or fewer out-of-home displays 512A-512C compared to the embodiment depicted in FIG. 5.

Stationary out-of-home displays 512A-512C can include store displays, kiosks on pedestrian malls or walkways, billboards, or other such displays. Sensors 516A-516C such as cameras, motion sensors, person-counters, or other similar sensors can be used to detect engagement with each of the stationary out-of-home displays 512A-512C. As previously described with respect to system 300 of FIG. 3, system 500 of FIG. 5 can send such data to server 518 which can store, manipulate, and/or send data to advertisers 520 to determine the number of “visual clicks” on a particular out-of-home display.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as will be understood by persons of ordinary skill in the art. Moreover, unless otherwise noted, elements described with respect to one embodiment can be implemented in other embodiments even when not described in such embodiments.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for assisting law enforcement in apprehending particular drivers or vehicles, the system comprising:
a first plurality of remote messaging platforms;
a second plurality of sensors, wherein
each of the sensors associated with a corresponding one of the first plurality of remote messaging platforms; and
each of the sensors is configured to generate a message upon detection of particular vehicles; and
a server, wherein the server is configured to receive the message and communicate the message to law enforcement via wireless connection.

2-15. (canceled)

16. A method for measuring a level of engagement with each of a plurality of remote messages, the method comprising:
providing a first plurality of remote messaging platforms;
providing a second plurality of sensors, at least one of the second plurality of sensors corresponding to each of the first plurality of remote messaging platforms;
providing a server;
detecting, at each of the second plurality of sensors, a level of engagement with a message associated with the corresponding one of the first plurality of remote messaging platforms; and
sending, at each of the first plurality of sensors, the corresponding gathered engagement data from the server to an advertising agency; and
conducting market tests based on specific geographies thus performing geomarketing.

17-23. (canceled)

24. A system for measuring engagement with a message, the system comprising:
a first plurality of remote messaging platforms, wherein the plurality of remote messaging platforms include a subset of mobile remote messaging platforms and subset of stationary remote messaging platforms;
a second plurality of sensors, wherein
each of the sensors associated with a corresponding one of the first plurality of remote messaging platforms; and
each of the sensors is configured to generate a message upon detection of particular vehicles; and
wherein each of the second plurality of sensors is configured to detect a level of engagement with a message associated with the corresponding one of the first plurality of remote messaging platforms.
